(19) United States
(12) Patent Application Publication
(10) Pub. No.: US 2025/0096285 A1
(43) Pub. Date: Mar. 20, 2025

(54) HUMIDIFIER

(71) Applicant: MAHLE International GmbH, Stuttgart (DE)

(72) Inventors: Samuel Kohler, Weil im Schoenbuch (DE); Tobias Baumgart, Winterbach (DE)

(21) Appl. No.: 18/889,365

(22) Filed: Sep. 18, 2024

(30) Foreign Application Priority Data
Sep. 19, 2023 (DE) 10 2023 209 089.9

(51) Int. Cl. H01M 8/04119; H01M 8/0273

(52) U.S. Cl. CPC H01M 8/04149; H01M 8/0273; H01M 8/04141; H01M 2250/20

(57) ABSTRACT

A humidifier, such as for a fuel cell system for a vehicle with a fuel cell for humidifying a dry air flowing to the fuel cell with a humid air flowing from the fuel cell, may include a membrane stack including a stack of flat membranes, a housing in which the membrane stack is accommodated, and two circumferential seals clamped between the membrane stack and the housing. The membrane stack may have two opposite lateral faces aligned parallel to a stacking direction for an inflow and an outflow of dry air, two further opposing lateral faces aligned parallel to the stacking direction for an inflow and an outflow of humid air, and/or two airtight end faces aligned transversely to the stacking direction. The two seals may separate the two further lateral faces from one another, from the two lateral faces, and from the two end faces in an airtight manner.

### CROSS-REFERENCE TO RELATED APPLICATION

This application claims priority to German Patent Application No. DE 10 2023 209 089.9, filed on Sep. 19, 2023, the contents of which is hereby incorporated by reference in its entirety.

### TECHNICAL FIELD

The invention relates to a humidifier for a fuel cell system for a vehicle, in particular for a vehicle powered by the fuel cell system, having a fuel cell for humidifying a dry air flowing to the fuel cell with a humid air flowing from the fuel cell. The invention also relates to the fuel cell system with the fuel cell and the humidifier.

### BACKGROUND

A humidifier can be used in a fuel cell system with a fuel cell. The humidifier can humidify dry air flowing to the fuel cell with humid air flowing from the fuel cell. The fuel cell is usually a stack, i.e., a pile of individual fuel cell elements stacked on top of each other. The humidifier usually comprises a stack of membranes with a plurality of membranes stacked at a distance in the stacking direction. The dry air and the humid air can flow through the membrane stack without mixing in a cross flow, so that humidity or water vapor can be transferred from the humid air to the dry air via the membranes. The membrane stack is accommodated in a housing and sealed to the housing in such a way that the dry air and the humid air in the housing can flow to and from the membrane stack without mixing.

As the air continuously loses pressure as it flows through the fuel cell system, the pressure in the dry air and the resulting pressure in the membrane stack is significantly higher than the pressure in the humid air. This creates large forces within the housing between the areas through which the dry air flows and the membrane stack and the areas through which the humid air flows. This can deform the membrane stack in particular and, in the worst case, damage the bonding of the membranes. Accordingly, the membrane stack must be sufficiently stable, which is associated with additional effort during production and additional costs.

### SUMMARY

The task of the invention is therefore to specify an improved or at least alternative embodiment for a humidifier of the type according to the present invention, in which the disadvantages described are overcome. The task of the invention is also to provide a corresponding fuel cell system with the humidifier.

According to the invention, this problem is solved by the subject matter of the independent claim(s). Advantageous embodiments are the subject matter of the dependent claim(s).

The present invention is based on the general idea of sealing the membrane stack to the housing on the humid side of the humidifier—wet-wet sealing—and thereby avoiding or at least reducing the deformation of the membrane stack during operation of the humidifier.

The humidifier according to the invention is intended or designed for a fuel cell system for a vehicle with a fuel cell. The humidifier according to the invention is provided or designed in particular for a fuel cell system for a vehicle powered by the fuel cell system or a fuel cell of the fuel cell system. In particular, the humidifier is intended or designed to humidify dry air flowing to the fuel cell with humid air flowing from the fuel cell. The humidifier has a membrane stack consisting of a plurality of flat membranes, wherein the membranes in the membrane stack are stacked at a distance from each other in a stacking direction. The membrane stack has four lateral faces aligned parallel to the stacking direction and two end faces aligned transverse to the stacking direction. Two opposing lateral faces are provided or designed for the inflow and outflow of humid air into and out of the membrane stack and two other opposing lateral faces are provided or designed for the inflow and outflow of dry air into and out of the membrane stack. The end faces of the membrane stack are airtight. Furthermore, the humidifier has a housing and the membrane stack is accommodated in the housing. The humidifier has two circumferential seals, wherein the respective seals are clamped between the membrane stack and the housing in an airtight manner. According to the invention, the respective seals are assigned to the lateral faces for the humid air and separate the respective lateral faces for the humid air from each other and from the lateral faces for the dry air and the end faces inside the housing in an airtight manner.

In the context of the present invention, the phrases “for the dry air” and “in the dry air” are used synonymously with the phrase “on the dry air side”. Similarly, the phrases “for the humid air” and “in the humid air” are used synonymously with the phrase “on the humid air side”.

In the membrane stack, the membranes are stacked on top of each other in the stacking direction. In particular, the membranes can be airtight and permeable to humidity or water vapor, so that humid air and dry air cannot flow through the membranes in the membrane stack and can still exchange humidity or water vapor with each other. The membranes can be rectangular and flexible.

Ducts on the humid air side and ducts on the dry air side can be formed between the membranes, which can alternate in the stacking direction. The respective ducts on the dry air side and the respective ducts on the humid air side can be arranged transversely to the stacking direction in a cross flow, so that air can flow through them. For this purpose, the respective ducts on the dry air side can connect the lateral faces of the membrane stack on the dry air side in an air-conducting manner and be separated from the lateral faces of the membrane stack on the humid air side in an airtight manner. Accordingly, the respective ducts on the humid air side can connect the lateral faces of the membrane stack on the humid air side in an air-conducting manner and be separated from the lateral faces of the membrane stack on the dry air side in an airtight manner. The individual adjacent membranes can be glued together by means of two edge-side adhesive strips and the respective ducts between the membranes can also be formed by these edge-side adhesive strips. Spacers can be arranged between the membranes, which can be glued to the membranes using the adhesive strips on the edges.

The membrane stack itself can be cuboidal. The lateral faces and the end faces of the membrane stack can completely form its outer surface or completely separate the membrane stack from the outside. The respective seals are circumferentially shaped and can run around the lateral faces of the membrane stack on the humid air side. The respective seals can be elastic, for example.

During the operation of the humidifier, the pressure prevailing in the dry air or pressure on the dry air side prevails on the lateral faces on the dry air side, and the pressure prevailing in the humid air or pressure on the humid air side prevails on the lateral faces on the humid air side. In the membrane stack itself, the areas of the pressure on the dry air side and pressure on the humid air side alternate. Overall, the resulting pressure in the membrane stack corresponds approximately to the pressure on the dry air side. As the air continuously loses pressure as it flows through the fuel cell system, the pressure on the dry air side is significantly higher than the pressure on the humid air side. For example, the dry air can have a pressure of approx. 3 bar and the humid air a pressure of approx. 2 bar. A pressure difference of approx. 1 bar can therefore occur between individual areas in the housing of the humidifier.

The respective seals can separate the respective lateral surfaces on the humid air side from the respective lateral surfaces on the dry air side and from the end faces in such an airtight manner that a pressure on the dry air side prevails within the housing on the lateral surfaces on the dry air side and on the end faces during operation of the humidifier. As a result, there is comparable pressure at the end faces of the membrane stack inside and outside the membrane stack and the inflation of the membrane stack in the stacking direction or at the end faces can be avoided or at least significantly reduced. In other words, an imbalance of forces caused by the pressure differences inside and outside the membrane stack can be avoided or at least reduced. This prevents damage to the membrane stack. In addition, airtight separation of the two lateral faces on the dry air side from each other can be simplified, as the pressure is almost evenly distributed on the lateral faces on the dry air side and on the end faces. In particular, there is no strong flow of dry air from one lateral face on the dry air side to the other lateral face on the dry air side around the membrane stack due to the almost uniform pressure distribution. This means that a complex and completely airtight sealing of the two lateral faces from each other on the dry air side is not necessary and the effort involved in manufacturing the humidifier and the costs can be reduced.

In one possible embodiment of the humidifier, the membrane stack can have two scaling plates. The sealing plates can bear against the last membranes in an airtight manner in the stacking direction and form the end faces of the membrane stack. The sealing plates can therefore be part of the membrane stack. The sealing plates can, for example, be made of plastic and/or be bonded—for example glued—to the last membrane in the stacking direction.

The membrane stack can be at least partially sealed to the housing at the respective sealing plates in such a way that a pressure on the dry air side prevails inside the housing on the lateral faces on the dry air side and on the end faces when the humidifier is in operation. The membrane stack can be at least partially sealed to the housing at the respective sealing plates and connected via a bypass in an air-conducting manner, in such a way that a pressure on the dry air side prevails inside the housing on the lateral faces on the dry air side and on the end faces when the humidifier is in operation. As described above, this can prevent or at least significantly reduce the inflation of the membrane stack in the stacking direction or at the end faces and avoid the need for a complex and completely airtight sealing of the two lateral faces from each other on the dry air side.

The membrane stack can have two labyrinth seals facing away from the membranes on the respective sealing plates. The respective labyrinth seals can bear against the housing in an airtight manner and separate the housing into at least partially airtight areas. Alternatively, the membrane stack can have two seals clamped between the respective sealing plates and the housing. The respective seals can separate the housing into at least partially airtight areas in the same way.

In the humidifier, the lateral faces on the humid air side are therefore separated from each other and from the lateral faces on the dry air side and the end faces by two circumferential seals. The sealing of the lateral faces on the humid air side can be completely airtight. The two lateral faces on the dry air side can be separated inside the housing by the two labyrinth seals or the two gaskets. As there is no strong flow of dry air from one lateral face on the dry air side to the other lateral face on the dry air side around the membrane stack due to the near uniform pressure, the sealing of the lateral faces on the dry air side can only be partially airtight. This significantly reduces the effort required to seal the membrane stack in the housing.

In one possible embodiment of the humidifier, the membrane stack can have two sealing frames. The respective sealing frames can bear against the edge of the lateral faces on the humid air side and run around them. The respective sealing frames can be connected in an airtight manner to the lateral faces on the humid air side and the respective seals can be clamped between the respective sealing frames and the housing. The respective sealing frames can, for example, be molded from plastic and/or bonded—for example glued—to the lateral faces on the humid air side.

One seal can be arranged on one sealing frame and the other seal on the other sealing frame in such a way that the respective seals are pressed against the housing in opposite directions by the respective sealing frames. In other words, the two seals can be arranged facing away from the respective lateral faces on the humid air side on the respective sealing frames.

The housing of the humidifier can have two separate or distinct housing parts-a first housing part and a second housing part. The respective seals can then be pressed against the different housing parts of the housing by the respective sealing frames. When installing the humidifier, the membrane stack can be inserted into the first-appropriately pot-shaped-housing part in a direction perpendicular to the lateral face on the humid air side. The one scal can then be clamped between the first housing part and the one sealing frame after the membrane stack has been inserted. The second housing part can then be attached to the first housing part, wherein the membrane stack is clamped between the two housing parts. This allows the other seal to be clamped between the other sealing frame and the second housing part. One seal is then pressed against the housing in one direction or insertion direction and the other seal is then pressed against this direction in another direction or against the insertion direction by the associated sealing frame.

Alternatively, one seal can be arranged on one sealing frame and the other seal on the other sealing frame in such a way that the respective seals are pressed against the housing in the same direction or insertion direction by the respective sealing frames. In other words, the two seals can be aligned in the same direction or insertion direction on the membrane stack. One seal can face away from the associated lateral face on the humid air side and the other seal can be arranged on the respective sealing frame facing the associated lateral face on the humid air side. The lateral face on the humid air side and the seal facing it can be arranged on one side of the sealing frame, for example. In this case, the gasket can run around the membrane block and the respective lateral face on the humid air side.

The housing can have two separate or distinct housing parts-a first housing part and a second housing part. The respective seals can then be pressed against the same housing part of the housing—for example, the first housing part—by the respective sealing frames. When installing the humidifier, the membrane stack can be inserted into the first-appropriately pot-shaped-housing part in a direction perpendicular to the lateral face on the humid air side. The humidifier is pushed forward into the first housing part with the seal facing away from the associated lateral face on the humid air side. The two seals are arranged between the first housing part and the respective sealing frames after the membrane stack has been inserted. The second housing part can then be attached to the first housing part, wherein the membrane stack is clamped between the housing parts. The two seals are then pressed against the first housing part in the direction of insertion by the associated sealing frame.

The invention also relates to a fuel cell system for a vehicle with a fuel cell and the humidifier described above. The fuel cell system according to the invention is provided or designed in particular for a vehicle powered by the fuel cell system or a fuel cell of the fuel cell system. The humidifier is connected to the fuel cell in an air-conducting manner so that the dry air that flows to the fuel cell and humid air that flows from the fuel cell can flow through the humidifier. The dry air can flow through the lateral faces for the dry air and the humid air can flow through the lateral faces for the humid air. The fuel cell system can, for example, have a compressor that is connected upstream of the humidifier on the dry air side. The dry air can flow directly after the compressor to the humidifier when the fuel cell system or humidifier is in operation. The dry air can then be humidified in the humidifier and flow further to the fuel cell. Humid air can then flow from the fuel cell into the humidifier and humidify the dry air. The humid air flows through a longer distance in the fuel cell system than the dry air and can have a lower pressure than the dry air. In order to avoid repetitions, reference is made here to the above explanations.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown in the images, in each case systematically:

FIG. 1 shows a sectional view of a humidifier according to the invention in a first embodiment;

FIG. 2 shows a view of the humidifier according to the invention in the first embodiment with a transparent housing part;

FIG. 3 shows a view of the humidifier according to the invention in the first embodiment without a housing part;

FIG. 4 shows a sectional view of the humidifier according to the invention in a second embodiment.

### DETAILED DESCRIPTION

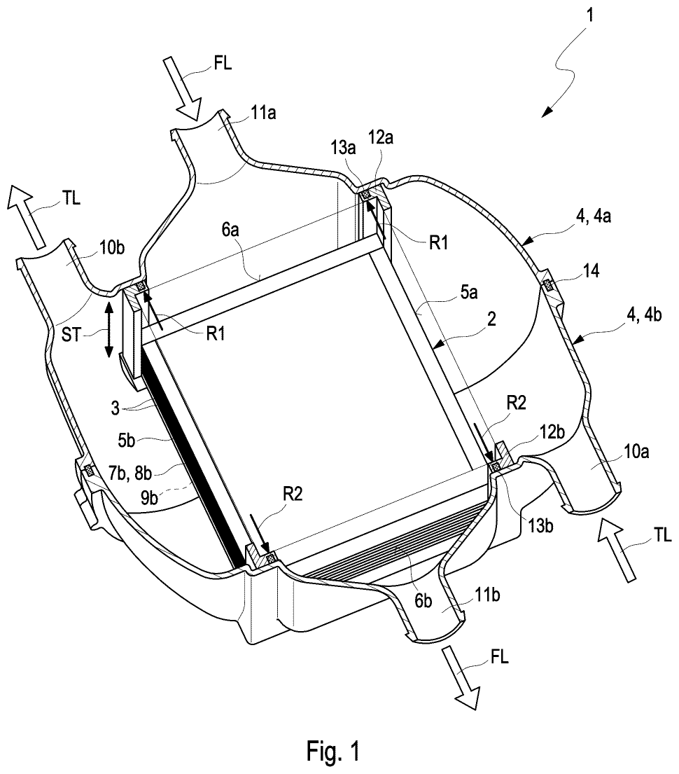

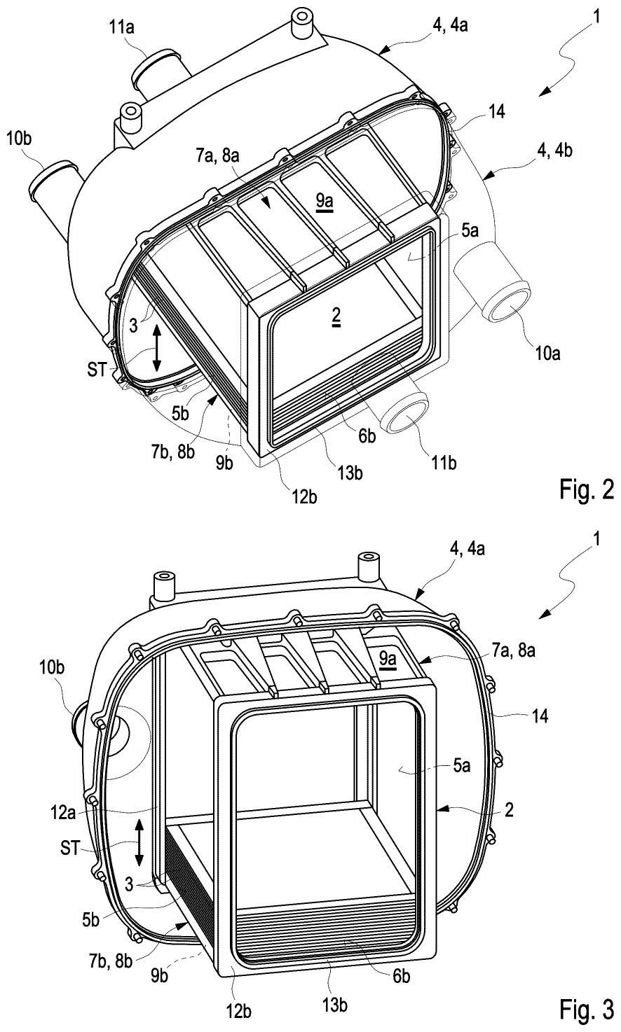

FIG. 1 shows a sectional view of a humidifier 1 according to the invention in a first embodiment. FIG. 2 and FIG. 3 show different views of the humidifier 1 according to the invention in the first embodiment. The humidifier 1 is intended or designed for a fuel cell system with a fuel cell—not shown here—for humidifying a dry air TL flowing to the fuel cell with a humid air FT flowing from the fuel cell. The humidifier 1 has a membrane stack 2 with a plurality of flat membranes 3 stacked in a stacking direction ST and a housing 4 with a first housing part 4a and a second housing part 4b. In FIG. 1 through FIG. 3, only a few membranes 3 are shown for clarity. In FIG. 2, the second housing part 4b is shown transparent and in FIG. 3, the second housing part 4b is not shown.

The membrane stack 2 is rectangular in shape and has two lateral faces 5a and 5b, through which air can flow, for the dry air TL and two lateral faces 6a and 6b, through which air can flow, for the humid air FL. Furthermore, the membrane stack 2 has two airtight end faces 7a and 7b. The lateral faces 5a and 5b on the dry air side are opposite each other in the membrane stack 2 and are aligned parallel to the stacking direction ST. The lateral faces 6a and 6b on the humid air side face each other in the same way and are aligned parallel to the stacking direction ST. The end faces 7a and 7b are aligned transverse to the stacking direction ST. The membrane stack 2 has two sealing plates 8a and 8b—see FIG. 2 and FIG. 3—which bear against the last membranes 3 in an airtight manner in the stacking direction ST. The sealing plates 8a and 8b are bonded to the respective membranes 3—for example glued—and form the end faces 7a and 7b of the membrane stack 2. Labyrinth seals 9a and 9b—see FIG. 2 and FIG. 3—are integrally formed on the sealing plates 8a and 8b.

The individual membranes 3 are stacked and bonded together in the membrane stack 2 in such a way that the dry air TL can flow through the membrane stack 2 from the lateral face 5a to the lateral face 5b and the humid air FL can flow through the membrane stack 2 from the lateral face 6a to the lateral face 6b without mixing in a cross flow. The membranes 3 are permeable to humidity or water vapor and airtight, so that the dry air TL and the humid air FL can exchange humidity or water vapor via the membranes 3.

An inlet 10a and an outlet 10b for the dry air TL and an inlet 11a and an outlet 11b for the humid air FL are formed in the housing 4. The inlet 10a on the dry air side is assigned to the lateral face 5a on the dry air side and the outlet 10b on the dry air side is assigned to the lateral face 5b on the dry air side and connected to these in an air-conducting manner. In addition, the inlet 11a on the humid air side is assigned to the lateral face 6a on the humid air side and the outlet 11b on the humid air side is assigned to the lateral face 6b on the humid air side and connected to these in an air-conducting manner.

The membrane stack 2 also has two sealing frames 12a and 12b, which are assigned to the lateral faces 6a and 6b on the humid air side. The sealing frames 12a and 12b are in sealing contact with the edges of the lateral faces 6a and 6b on the humid air side and are glued to the lateral faces 6a and 6b on the humid air side, for example. Two circumferential seals 13a and 13b of the humidifier 1 are also clamped between the respective sealing frames 12a and 12b and the housing 4 in an airtight manner.

In the first embodiment of the humidifier 1, the respective seals 13a and 13b are arranged facing away from the respective lateral faces 6a and 6b on the respective sealing frames 12a and 12b. As a result, the two seals 13a and 13b are pressed in an airtight manner in opposite directions R1 and R2 and against different housing parts 4a and 4b by the respective sealing frames 12a and 12b. When mounting the humidifier 1, the membrane stack 2 with the seal 13a can therefore first be pushed into the first housing part 4a in the direction R1, thereby arranging the seal 13a between the sealing frame 12a and the first housing part 4a. Subsequently, the second housing part 4b can be arranged on the first housing part 4a, thereby arranging the second seal 13b between the sealing frame 12b and the second housing part 4b. The first housing part 4a and the second housing part 4b can then be connected to each other in an airtight manner—in this case via a circumferential seal 14. At the same time, the respective seals 13a and 13b can be clamped or pressed between the respective sealing frames 12a and 12b and the respective housing parts 4a and 4b in an airtight manner.

In the humidifier 1, the lateral faces 6a and 6b on the humid air side are sealed towards the housing 4 by means of the seals 13a and 13b. This separates the inlet 11a and outlet 11b from the inlet 10a and outlet 10b in an airtight manner. The labyrinth seals 9a and 9b are in scaling contact with the housing 4 and separate the inlet 10a and the outlet 10b from each other in an airtight or at least partially airtight manner.

During operation of the humidifier 1, a pressure on the dry air side prevails on the lateral faces 5a and 5b on the dry air side and a pressure on the humid air side prevails on the lateral faces 6a and 6b on the humid air side. In the membrane stack 2, the areas of the pressure on the dry air side and pressure on the humid air side alternate. Overall, the resulting pressure in the membrane stack 2 corresponds approximately to the pressure on the dry air side. As the lateral faces 6a and 6b on the humid air side are separated from other areas of the housing 4 in an airtight manner by the seals 13a and 13b, the pressure on the dry air side prevails on the lateral faces 5a and 5b on the dry air side, and also on the outside of the end faces 7a and 7b. Accordingly, the resulting pressure inside the membrane stack 2 and the pressure outside the membrane stack 2 are almost identical. This prevents or at least reduces deformation or swelling of the membrane stack 2 at the end faces 7a and 7b.

Due to the almost uniform pressure on the lateral faces 5a and 5b on the dry air side and the end faces 7a and 7b, there is also no strong flow of dry air TL from the side surface 5a on the dry air side to the lateral face 5b on the dry air side, around the membrane stack 2, so that the labyrinth seals 13a and 13b do not have to separate the lateral faces 5a and 5b on the dry air side from each other in a completely airtight manner. In other words, the respective labyrinth seals 9a and 9b can also bypass the dry air TL around the membrane stack 2. This can reduce the effort involved in manufacturing the humidifier 1 and the cost of the humidifier 1.

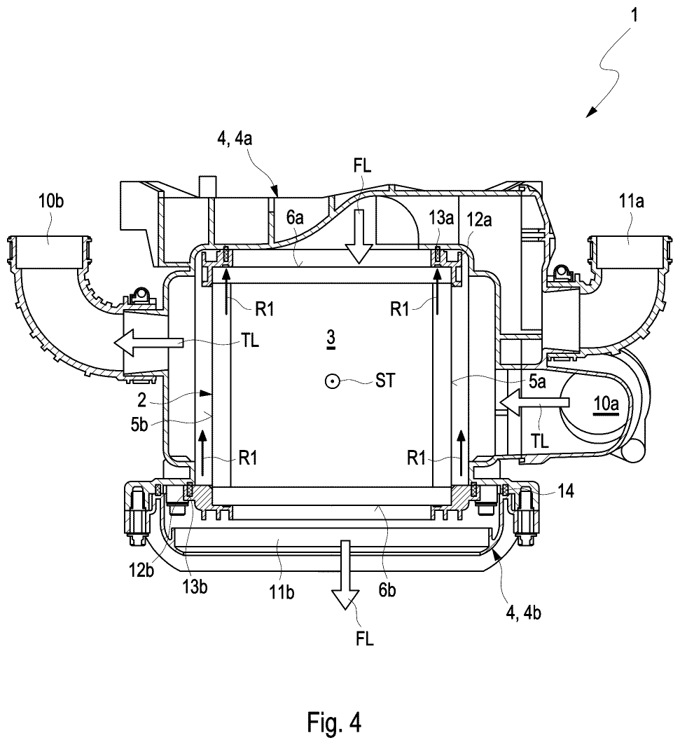

FIG. 4 shows a sectional view of the humidifier 1 according to the invention in a second embodiment. In the second embodiment, the seal 13a is arranged on the sealing frame 12a facing away from the lateral face 6a on the humid air side. The seal 13b, on the other hand, is arranged on the sealing frame 12b facing the lateral face 6b on the humid air side. In other words, the seal 13b and the lateral face 6b are arranged on one side of the sealing frame 12b. As a result, the two seals 13a and 13b are pressed against the first housing part 4a in an airtight manner in a common direction R1 by the respective sealing frames 12a and 12b. Accordingly, when mounting the humidifier 1, the membrane stack 2 with the seal 13a and the seal 13b can first be pushed into the housing part 4a in the direction R1 and thereby the seals 13a and 13b can be arranged between the respective associated sealing frames 12a and 12b and the first housing part 4a. The second housing part 4b can then be arranged on the first housing part 4a and connected to the second housing part 4b in an airtight manner—in this case via the circumferential seal 14. At the same time, the respective seals 13a and 13b can be clamped or pressed between the respective sealing frames 12a and 12b and the first housing part 4a in an airtight manner. Otherwise, the first embodiment and the second embodiment of the humidifier 1 are identical.

1. A humidifier for a fuel cell system for a vehicle with a fuel cell for humidifying a dry air flowing to the fuel cell with a humid air flowing from the fuel cell, comprising:
a membrane stack including a plurality of flat membranes stacked in the membrane stack at a distance from one another in a stacking direction;
the membrane stack has having two opposite lateral faces aligned parallel to the stacking direction for an inflow and an outflow of the dry air into and out of the membrane stack;
the membrane stack further having two further opposing lateral faces aligned parallel to the stacking direction for an inflow and an outflow of the humid air into and out of the membrane stack;
the membrane stack has further having two airtight end faces aligned transversely to the stacking direction;
a housing in which the membrane stack is accommodated; and
two circumferential seals clamped between the membrane stack and the housing in an airtight manner;
wherein the two seals are assigned to the two further lateral faces for the humid air and separate the two further lateral faces for the humid air within the housing from one another and from the two lateral faces for the dry air and from the two end faces in an airtight manner.

2. The humidifier according to claim 1, wherein the two seals separate the two further lateral faces for the humid air from the two lateral faces for the dry air and from the two end faces in such an airtight manner that a pressure prevailing in the dry air prevails within the housing at the two lateral faces for the dry air and at the two end faces during operation of the humidifier.

3. The humidifier according to claim 1, wherein the membrane stack includes two scaling plates bearing against a respective last membrane of the plurality of flat membranes in the stacking direction in an airtight manner and forming the two end faces of the membrane stack.

4. The humidifier according to claim 3, wherein at least one of:
the membrane stack is at least partially sealed to the housing at the two scaling plates in such a way that a pressure prevailing in the dry air prevails within the housing at the two lateral faces for the dry air and at the two end faces during operation of the humidifier; and
the membrane stack is at least partially sealed to the housing at the two sealing plates and is connected in an air-conducting manner via a bypass in such a way that a pressure prevailing in the dry air prevails within the housing at the two lateral faces for the dry air and at the two end faces during operation of the humidifier.

5. The humidifier according to claim 3, wherein the membrane stack further includes at least one of:
two labyrinth seals arranged on the two scaling plates facing away from the plurality of stacked membranes, the two labyrinth seals bearing against the housing in an airtight manner and separating the housing into a plurality of regions that are at least partially separated from one another in an airtight manner; and
two additional seals clamped between the two scaling plates and the housing, the two additional seals separating the housing into a plurality of at least partially airtightly separated regions.

6. The humidifier according to claim 1, wherein:
the membrane stack further includes two scaling frames bearing against a plurality of edges of the two further lateral faces for the humid air and extending around the two further lateral faces;
the two sealing frames are connected in an airtight manner to the two further lateral faces for the humid air; and
the two seals are clamped between the two scaling frames and the housing in an airtight manner.

7. The humidifier according to claim 6, wherein a first seal of the two seals is arranged on a first sealing frame of the two sealing frames and a second seal of the two seals is arranged on a second sealing frame of the two sealing frames such that the two seals are pressed against the housing in opposite directions via the two scaling frames.

8. The humidifier according to claim 7, wherein the housing includes two separate housing parts and the respective two seals are pressed against different housing parts of the two housing parts via the two scaling frames.

9. The humidifier according to claim 6, wherein a first seal of the two seals is arranged on a first sealing frame of the two sealing frames and a second seal of the two seals is arranged on a second scaling frame in of the two scaling frames such that the two seals are pressed against the housing in the same direction via the two sealing frames.

10. The humidifier according to claim 9, wherein the housing includes two separate housing parts and the two seals are pressed against the same housing part of the two housing parts via the two sealing frames.

11. A fuel cell system for a vehicle, comprising:
a fuel cell; and
a humidifier according to claim 1;
wherein the humidifier is connected to the fuel cell in an air-conducting manner such that dry air flowable to the fuel cell and humid air flowable from the fuel cell are flowable through the humidifier; and
wherein the dry air is flowable through the two lateral faces for the dry air and the humid air is flowable through the two further lateral faces for the humid air.

12. The fuel cell system according to claim 11, wherein the two seals separate the two further lateral faces for the humid air from the two lateral faces for the dry air and from the two end faces in such an airtight manner that a pressure prevailing in the dry air prevails within the housing at the two lateral faces for the dry air and at the two end faces during operation of the humidifier.

13. The fuel cell system according to claim 11, wherein the membrane stack includes two sealing plates bearing against a respective last membrane of the plurality of flat membranes in the stacking direction in an airtight manner and forming the two end faces of the membrane stack.

14. The fuel cell system according to claim 13, wherein at least one of:
the membrane stack is at least partially sealed to the housing at the two sealing plates in such a way that a pressure prevailing in the dry air prevails within the housing at the two lateral faces for the dry air and at the two end faces during operation of the humidifier; and
the membrane stack is at least partially sealed to the housing at the two sealing plates and is connected in an air-conducting manner via a bypass in such a way that a pressure prevailing in the dry air prevails within the housing at the two lateral faces for the dry air and at the two end faces during operation of the humidifier.

15. The fuel cell system according to claim 13, wherein the membrane stack further includes at least one of:
two labyrinth seals arranged on the two sealing plates facing away from the plurality of stacked membranes, the two labyrinth seals bearing against the housing in an airtight manner and separating the housing into a plurality of regions that are at least partially separated from one another in an airtight manner; and
two additional seals clamped between the two sealing plates and the housing, the two additional seals separating the housing into a plurality of at least partially airtightly separated regions.

16. The fuel cell system according to claim 11, wherein:
the membrane stack further includes two sealing frames bearing against a plurality of edges of the two further lateral faces for the humid air and extending around the two further lateral faces;
the two sealing frames are connected in an airtight manner to the two further lateral faces for the humid air; and
the two seals are clamped between the two sealing frames and the housing in an airtight manner.

17. The fuel cell system according to claim 16, wherein a first seal of the two seals is arranged on a first sealing frame of the two sealing frames and a second seal of the two seals is arranged on a second sealing frame of the two sealing frames such that the two seals are pressed against the housing in opposite directions via the two sealing frames.

18. The fuel cell system according to claim 17, wherein the housing includes two separate housing parts and the two seals are pressed against different housing parts of the two housing parts via the two sealing frames.

19. The fuel cell system according to claim 16, wherein a first seal of the two seals is arranged on a first sealing frame of the two sealing frames and a second seal of the two seals is arranged on a second sealing frame of the two sealing frames such that the two seals are pressed against the housing in the same direction via the two sealing frames.

20. The fuel cell system according to claim 19, wherein the housing includes two separate housing parts and the two seals are pressed against the same housing part of the two housing parts via the two sealing frames.
